(19) United States
(12) Patent Application Publication
(10) Pub. No.: US 2005/0194545 A1
(43) Pub. Date: Sep. 8, 2005

(54) [ADJUSTABLE COLLIMATOR AND SPUTTERING APPARATUS WITH THE SAME]

(76) Inventors: Cheng-Shih Lee, Taoyuan County (TW); Edward Yi Chang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,487

(22) Filed: May 10, 2004

(30) Foreign Application Priority Data
Mar. 8, 2004 (TW) 93106007

(51) Int. Cl. G21K 5/00; C25B 9/00; G01N 21/01

(52) U.S. Cl. 250/438; 204/298.01

(57) ABSTRACT

An adjustable collimator and a sputtering apparatus with the same are provided. The adjustable collimator comprises an adjustable main body, first and second collimating elements. The adjustable main body has an interior space, a top portion, a bottom portion and an adjuster between the top portion and the bottom portion. The adjuster is adapted for adjusting a relative distance between the top portion and the bottom portion. A first collimating element fixed inside the interior space of the top portion in a manner to move with the top portion and a second collimating element fixed inside the interior space of the bottom portion to move with the bottom portion. When the adjustable collimator applies to sputtering apparatus, it can easily control the incident angel of the molecule of the sputtering material by adjusting a relative distance between the top and bottom portion.

### CROSS REFERENCE TO RELATED APPLICATIONS

This application claims the priority benefit of Taiwan application serial no. 93106007, filed Mar. 8, 2004.

### BACKGROUND OF INVENTION

1. Field of the Invention

This invention generally relates to a collimator, and more particularly to an adjustable collimator and sputtering apparatus with the same. When the adjustable collimator is applied to the sputtering apparatus, it can easily control the incident angle of the molecule of the sputtering material.

2. Description of Related Art

In the semiconductor manufacturing processes, the liftoff process is often used. When manufacturing the device such as the high electron mobility transistor (HEMT), the metal semiconductor field effect transistor (MESFET), the metal-oxide-semiconductor field effect transistor (MOSFET), or complementary metal oxide semiconductor (CMOS), because the critical dimension is very narrow, it is necessary to utilize the collimator to precisely sputter the material onto the chip during the sputtering process.

FIG. 1 is a cross sectional view of a conventional sputtering apparatus. Referring to FIG. 1, the conventional sputtering apparatus 100 includes the chamber 102, the holding base 104 and the collimator 106. There is a metal target material 108 inside the chamber 102. The holding base 104 is disposed inside the chamber 102 and is opposite to the metal target material 108 for holding the chip. The collimator 106 is fixed between the holding base 104 and the metal target material 108.

However, because the distance between the hole of the collimator 106 and the chip 110 is fixed, to perform the processes for different line widths, the collimators with different bores have to be used, which increase the process complexity and the maintenance difficulty.

### SUMMARY OF INVENTION

The present invention is directed to an adjustable collimator to resolve the drawback that when performing the processes for different line widths, the collimators with different bores have to be used.

The present invention is directed to a sputtering apparatus for simplifying the process and reducing the maintenance difficulty.

According to an embodiment of the present invention, the sputtering apparatus can be easily to be disassembled.

According to an embodiment of the present invention, an adjustable collimator comprises an adjustable main body, a first collimating element and a second collimating element. The adjustable main body has an interior space and includes a top portion, a bottom portion, and an adjuster between the top portion and the bottom portion, wherein the adjuster is for adjusting a relative distance between the top portion and the bottom portion. The first collimating element is fixed inside the interior space of the top portion to move with the top portion, and the second collimating element is fixed inside the interior space of the bottom portion to move with the bottom portion.

In an embodiment of the present invention, the adjuster includes a rough adjustment element and a fine adjustment element. The shape of holes of the first collimating element can be the same or different from that of the second collimating element. In addition, the shape of the holes of the first collimating element is, for example, hexagonal, and the shape of the holes of the second collimating element can also be hexagonal.

The present invention provides a sputtering apparatus for sputtering a target material onto an object. According to an embodiment of the present invention, the sputtering apparatus comprises a chamber, a holding base and an adjustable collimator. A target material is disposed inside the chamber and the holding base is disposed inside the chamber opposite to the target material. The adjustable collimator is set between the holding base and the target material, and it includes an adjustable main body, a first collimating element and a second collimating element. The adjustable main body has an interior space and includes a top portion, a bottom portion, and an adjuster between the top portion and the bottom portion, wherein the adjuster is adapted for adjusting a relative distance between the top portion and the bottom portion. The first collimating element is fixed inside the interior space of the top portion to move with the top portion, and the second collimating element is fixed inside the interior space of the bottom portion to move with the bottom portion.

In an embodiment of the present invention, the adjuster includes a rough adjustment element and a fine adjustment element. The shape of holes of the first collimating element can be the same or different from that of the second collimating element. In addition, the shape of the holes of the first collimating element is, for example, hexagonal, and the shape of the holes of the second collimating element can also be hexagonal.

The present invention provides a sputtering apparatus for sputtering a target material onto an object, comprising a chamber, a holding base and an adjustable collimator. A target material is disposed inside the chamber and the holding base is disposed inside the chamber opposite to the target material. The adjustable collimator is disposed on the holding base to cover the object so that the adjustable collimator moves with the holding base. The adjustable collimator includes an adjustable main body, a first collimating element and a second collimating element. The adjustable main body has an interior space, and the adjustable main body includes a top portion, a bottom portion, and an adjuster between the top portion and the bottom portion, wherein the adjuster is for adjusting a relative distance between the top portion and the bottom portion. The first collimating element is fixed inside the interior space of the top portion to move with the top portion, and the second collimating element is fixed inside the interior space of the bottom portion to move with the bottom portion.

In an embodiment of the present invention, the adjuster includes a rough adjustment element and a fine adjustment element. The shape of holes of the first collimating element can be same or different from that of the second collimating element. In addition, the shape of the holes of the first collimating element is, for example, hexagonal, and the shape of the holes of the second collimating element can also be hexagonal.

Because the adjustable collimator is used to adjust the relative distance between the top and bottom portions to move these two collimating elements to the proper positions, and therefore the incident angle of the molecule of the sputtering material can be easily controlled. When the process with a smaller line width is to be performed, the distance between the two collimating elements can be extended. When the process with a larger line width is to be performed, the distance between the two collimating elements can be shortened. In addition, applying the present invention to the lift-off process or to the process for forming the T-gate, the improvement is more significant. Further, the embodiment of the present invention does not incur significant additonal cost and can resolve the drawback of the conventional sputtering apparatus.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is the cross-sectional view of a conventional sputtering apparatus.

FIG. 2 is a prospective view of the adjustable collimator in accordance with a first embodiment of the present invention.

FIG. 3 is the cross-sectional view of the adjustable collimator of FIG. 2 along the III-III line.

FIG. 4 is a prospective view of the sputtering apparatus in accordance with a second embodiment of the present invention.

FIG. 5 is a prospective view of the sputtering apparatus in accordance with a third embodiment of the present invention.

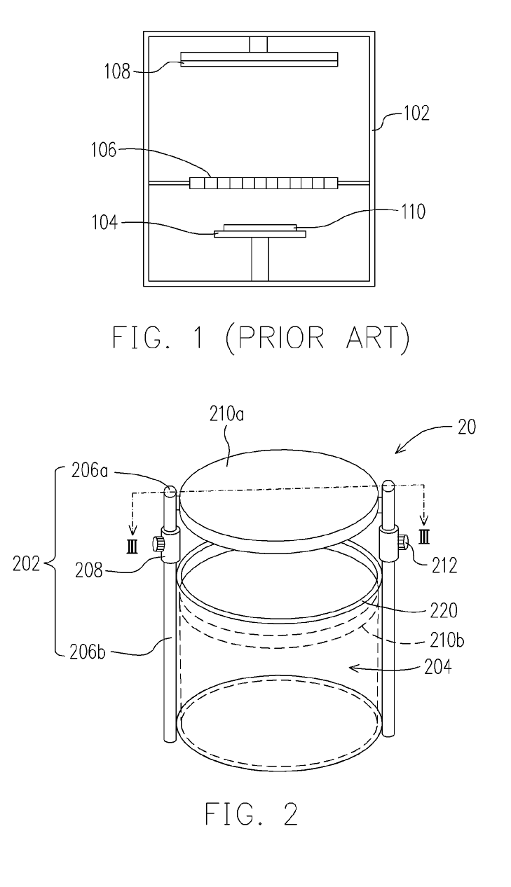

### DETAILED DESCRIPTION

### First Embodiment

FIG. 2 is a prospective view of the adjustable collimator in accordance with the first embodiment of the present invention.

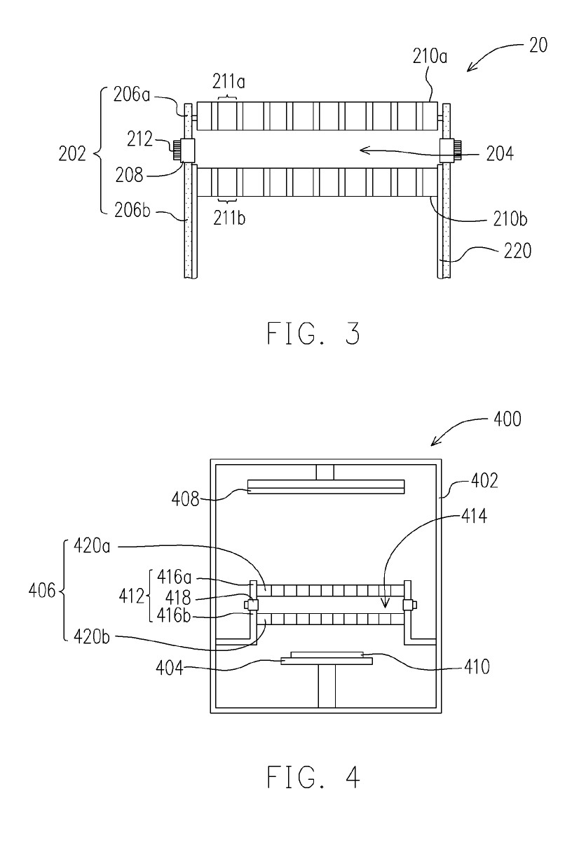

FIG. 3 is a cross-sectional view of the adjustable collimator of FIG. 2 along the III-III line. Referring to FIG. 3, the adjustable collimator 20 includes an adjustable main body 202, a first collimating element 210a and a second collimating element 210b. The adjustable main body 202 has an interior space 204. The adjustable main body 202 includes a top portion 206a, a bottom portion 206b, and an adjuster 208 between the top portion 206a and the bottom portion 206b. The adjuster 208 is adapted for adjusting a relative distance between the top portion 206a and the bottom portion 206b. The first collimating element 210a is fixed inside the interior space 204 of the top portion 206a in order to move with the top portion 206a. The second collimating element 210b is fixed inside the interior space 204 of the bottom portion 206b in order to move with the bottom portion 206b. Therefore, when the adjustable collimator is applied to the Physical Vapor Deposition (PVD) apparatus such as the sputtering apparatus, it can easily control the incident angle of the molecule of the sputtering material by adjusting the relative distance between the top portion 206a and bottom portion 206b, which at the same time adjusts the relative distance between two collimating elements 210a and 210b.

Referring to FIGS. 2 and 3, the adjuster 208 of the adjustable collimator 20 can be constructed by using conventional mechanical devices or structures in a manner to adjust the relative distance between the top portion 206a and bottom portion 206b. For example, in FIGS. 2 and 3, the adjuster 208 with the screw 212 is used to adjust the relative distance between the top portion 206a and bottom portion 206b. However, this embodiment cannot be used to limit the scope of the present invention. In addition, the adjuster 208 includes a rough adjustment element and a fine adjustment element to precisely adjust the relative distance between the first collimating element 210a and the second collimating element 210b. Further, the shape of holes of the first collimating element 210a in this embodiment can be same or different from that of the second collimating element 210b. For example, the shape of the holes of the first collimating element 210a is hexagonal; the shape of the holes of the second collimating element 210b can also be hexagonal. In addition, the adjustable collimator 20 can further comprises a mask 220 covering the portion of the adjustable main body 202 below the first collimating element 210a.

### Second Embodiment

FIG. 4 is a prospective view of the sputtering apparatus in accordance with the second embodiment of the present invention. Referring to FIG. 4, the sputtering apparatus 400 of the embodiment is for sputtering a target material 408 onto an object 410 such as a chip. The sputtering apparatus 400 comprises a chamber 402, a holding base 404 and an adjustable collimator 406. The target material 408 is disposed inside the chamber 402. The holding base 404 is disposed inside the chamber 402 opposite to the target material 408 for holding the object 410. The adjustable collimator 406 is between the holding base 404 and the target material 408. The adjustable collimator 406 includes an adjustable main body 412, a first collimating element 420a, and a second collimating element 420b. The adjustable main body 412 has an interior space 414. The adjustable main body 412 includes a top portion 416a, a bottom portion 416b, and an adjuster 418 between the top portion 416a and the bottom portion 416b. The adjuster 418 is adapted for adjusting a relative distance between the top portion 416a and the bottom portion 416b. The first collimating element 420a is fixed inside the interior space 414 of the top portion 416a in order to move with the top portion 416a. The second collimating element 420b is fixed inside the interior space 414 of the bottom portion 416b in order to move with the bottom portion 416b.

Referring to FIG. 4, the adjuster 418 of the adjustable collimator 406 can be constructed using conventional mechanical devices or structures in a manner to adjust the relative distance between the top portion 416a and bottom portion 416b as described above, and a detailed description thereof will not be repeated hereinafter again. In addition, the adjuster 418 includes a rough adjustment element and a fine adjustment element to precisely adjust the relative distance between the first collimating element 420a and the second collimating element 420b. Further, the shape of holes of the first collimating element 420a in this embodiment can be same or different from that of the second collimating element 420b. For example, the shape of the holes of the first collimating element 420a is hexagonal; the shape of the holes of the second collimating element 420b can also be hexagonal. In addition, the adjustable collimator 406 can further comprise a mask (not shown) covering the portion of the adjustable main body 412 below the first collimating element 420a to prevent the molecules of the target material from directly going to the object 410 and without being through the second collimating element 420b.

### Third Embodiment

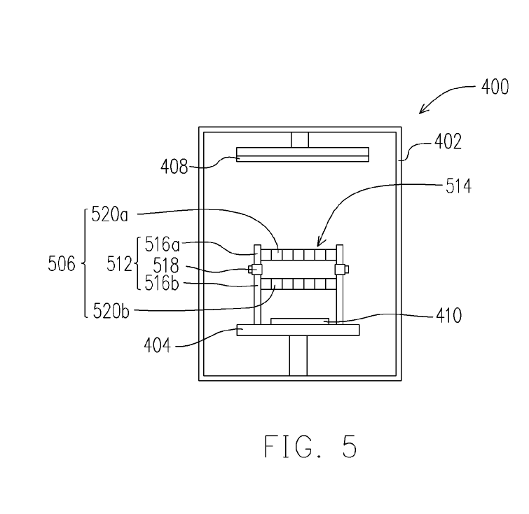

FIG. 5 is a prospective view of the sputtering apparatus in accordance with the third embodiment of the present invention. Referring to FIG. 5, the difference between the sputtering apparatus 500 in FIG. 5 and the sputtering apparatus 400 in FIG. 4 is that the adjustable collimator 506 is disposed on the holding base 404 to cover the object 410 so that the adjustable collimator 506 can move with the holding base 404; e.g., the adjustable collimator 506 can rotate with the holding base 404. The adjustable collimator 506 includes an adjustable main body 512, a first collimating element 520a, and a second collimating element 520b. The adjustable main body 512 has an interior space 514. The adjustable main body 512 includes a top portion 516a, a bottom portion 516b and an adjuster 518 between the top portion 516a and the bottom portion 516b. The adjuster 518 is adapted for adjusting a relative distance between the top portion 516a and the bottom portion 516b. The first collimating element 520a is fixed inside the interior space 514 of the top portion 516a in order to move with the top portion 516a. The second collimating element 520b is fixed inside the interior space 514 of the bottom portion 516b in order to move with the bottom portion 516b. In addition, the adjuster 518 of the adjustable collimator 506 can be constructed using conventional mechanical devices or structures in a manner to adjust the relative distance between the top portion 516a and bottom portion 516b. In addition, the adjuster 518 includes a rough adjustment element and a fine adjustment element to precisely adjust the relative distance between the first collimating element 520a and the second collimating element 520b. Further, the shape of holes of the first collimating element 520a in this embodiment can be same or different from that of the second collimating element 520b. For example, the shape of the holes of the first collimating element 520a is hexagonal; the shape of the holes of the second collimating element 520b can also be hexagonal. In addition, the adjustable collimator 506 can further comprise a mask (not shown) covering the portion of the adjustable main body 512 below the first collimating element 520a.

In light of the above, because the present invention utilizes the adjustable collimator to adjust the relative distance between the top and bottom portions so as to move these two collimating elements to the proper positions, and therefore the incident angle of the molecule of the sputtering material can be easily controlled. When the process with a smaller line width is to be performed, the distance between the two collimating elements can be extended. When the process with a larger line width is to be performed, the distance between the two collimating elements can be shortened. In addition, applying the present invention to the lift-off process or to the process for forming the T-gate, the effect due to the random incident angle of the molecules of the target material can be significantly reduced. Further, the application of the present invention does not incur significant additional cost and can resolve the drawback of the conventional sputtering apparatus.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. An adjustable collimator, comprising:
an adjustable main body, having an interior space, a top portion, a bottom portion and an adjuster between said top portion and said bottom portion, said adjuster being adapted for adjusting a relative distance between said top portion and said bottom portion;
a first collimating element, fixed inside said interior space of said top portion to move with said top portion; and
a second collimating element, fixed inside said interior space of said bottom portion to move with said bottom portion.

2. The adjustable collimator of claim 1, further comprising a mask covering said adjustable main body below said first collimating element.

3. The adjustable collimator of claim 1, wherein said adjuster includes a rough adjustment element and a fine adjustment element.

4. The adjustable collimator of claim 1, wherein a shape of holes of said first collimating element is same as that of said second collimating element.

5. The adjustable collimator of claim 1, wherein a shape of holes of said first collimating element is different from that of said second collimating element.

6. A sputtering apparatus for sputtering a target material onto an object, comprising:
a chamber, said target material, disposed inside said chamber;
a holding base, disposed inside said chamber opposite to said target material; and
an adjustable collimator, set between said holding base and said target material, said adjustable collimator including:
an adjustable main body, having an interior space, a top portion, a bottom portion and an adjuster between said top portion and said bottom portion, said adjuster being adapted for adjusting a relative distance between said top portion and said bottom portion;
a first collimating element, fixed inside said interior space of said top portion to move with said top portion; and
a second collimating element, fixed inside said interior space of said bottom portion to move with said bottom portion.

7. The sputtering apparatus of claim 6, further comprising a mask covering said adjustable main body below said first collimating element.

8. The sputtering apparatus of claim 6, wherein said adjuster includes a rough adjustment element and a fine adjustment element.

9. The sputtering apparatus of claim 6, wherein a shape of holes of said first collimating element is same as that of said second collimating element.

10. The sputtering apparatus of claim 6, wherein a shape of holes of said first collimating element is different from that of said second collimating element.

11. A sputtering apparatus for sputtering a target material onto an object, comprising:
a chamber, said target material being disposed inside said chamber;
a holding base, disposed inside said chamber opposite to said target material; and
an adjustable collimator, disposed on said holding base to cover said object so that said adjustable collimator moves with said holding base, said adjustable collimator including
an adjustable main body, having an interior space, a top portion, a bottom portion and an adjuster between said top portion and said bottom portion, said adjuster being adapted for adjusting a relative distance between said top portion and said bottom portion;
a first collimating element, fixed inside said interior space of said top portion to move with said top portion; and
a second collimating element, fixed inside said interior space of said bottom portion to move with said bottom portion.

12. The sputtering apparatus of claim 11, further comprising a mask covering said adjustable main body below said first collimating element.

13. The sputtering apparatus of claim 11, wherein said adjuster includes a rough adjustment element and a fine adjustment element.

14. The sputtering apparatus of claim 11, wherein a shape of holes of said first collimating element is same as that of said second collimating element.

15. The sputtering apparatus of claim 11, wherein a shape of holes of said first collimating element is different from that of said second collimating element.
